(19) United States
(12) Patent Application Publication
(10) Pub. No.: US 2017/0048933 A1
(43) Pub. Date: Feb. 16, 2017

(54) AIR-COOLED INDUCTION HEATING DEVICE

(71) Applicant: Mario Metodiev, West Islip, NY (US)

(72) Inventor: Mario Metodiev, West Islip, NY (US)

(21) Appl. No.: 14/825,330

(22) Filed: Aug. 13, 2015

(51) Int. Cl. H05B 6/42; F27D 11/06; F27D 1/12

(52) U.S. Cl. CPC H05B 6/42; F27D 1/12; F27D 11/06; F27D 2009/0005

(57) ABSTRACT

Disclosed is an air-cooled induction heating device for inductively heating a graphite susceptor and subsequently melting a metal contained within the susceptor. The device comprises a crucible for receiving a susceptor therewithin, an induction coil spirally encircling the crucible such that, no contact is observed therebetween, and a power supply source for powering the induction coil wherein, powering the induction coil results in the inductively heating up and subsequent melting of the susceptor.

### CROSS-REFERENCE TO RELATED APPLICATION

This application is a Continuation in Part of U.S. patent application 62/068,103 filed Oct. 24, 2014, entitled “Method and device for melting metals and alloys using air-cooled induction heating coil”, owned by the assignee of the present application and herein incorporated by reference in its entirety.

### BACKGROUND

### Field of the Invention

The present invention relates to induction heating equipment and more particularly to a compact air-cooled induction heating device for melting susceptors of relatively low melting points (such as, gold, silver, brass, copper, etc.) wherein, said device is designed to be efficient particularly in terms of the air-cooling thereof.

When it comes to melting metals and alloys, especially on a small scale, induction heating is arguably considered to be the best way to go about due to the induction heating equipment being generally cleaner, compact, and more efficient. A conventional induction heating device comprises a crucible for receiving a susceptor that is to be melted and an induction coil disposed around the susceptor wherein, as the induction coil is powered by a power source, an electromagnetic field is generated by the AC current in the induction coil, which leads to the inducement of eddy currents within the susceptor. This results in the heating up of the susceptor as the direction of the flow of the eddy currents is opposed to that of the AC current in the induction coil.

As it is well known in the art, the induction coil, which is generally made of copper, needs to be either air or water-cooled at regular intervals to ensure the longevity of the induction heating equipment. Although, air-cooled induction heating equipment (over their water-cooled counterparts) has the advantages of being cleaner and more convenient to handle, the primary disadvantage lies with the quality of cooling itself, meaning, water-cooling is more efficient compared to air-cooling.

Therefore, in the light of what is discussed, there is a need in the art for an improved air-cooled induction heating device that is particularly designed have better efficiency in terms of the air-cooling thereof.

### SUMMARY

The present invention comprises a device for inductively heating a graphite susceptor and subsequently melting a metal of a relatively low melting point such as, gold, silver, brass, copper, etc. The device comprises a crucible, the inner and outer layers of which are inlaid with a graphite layer and a thermal fiber layer respectively. An induction coil is spirally wound around the crucible such that, no contact is observed therebetween. The coil is made of high temperature litz or welding wire and lined with a thermal insulation layer, such as, of thermal epoxy, so as to provide sufficient thermal barrier between the induction coil and the susceptor.

The device further comprises a fan secured at one end of an air duct wherein, the air from the fan, as directed by the air duct, is delivered to the annular gap disposed between the induction coil and the outer surface of the crucible so as to air-cool the induction coil. In one embodiment, the air from the fan is pre-chilled. Powering the induction coil results in the generation of an electromagnetic field that inductively heats up of the susceptor within the crucible that leads to the subsequent melting thereof.

Other objects and advantages of the embodiments herein will become readily apparent from the following detailed description taken in conjunction with the accompanying drawings.

### BRIEF DESCRIPTION OF THE DRAWINGS

FIG. 1, according to an embodiment of the present invention, is an illustration of a perspective view of the induction heating device.

FIG. 2, according to an embodiment of the present invention, is an illustration of a side view of the induction heating device.

FIG. 3, according to an embodiment of the present invention, is an illustration of the assemblage of the crucible, induction coil and the air duct.

FIG. 4, according to an embodiment of the present invention, is another illustration of the assemblage of the crucible, induction coil and the air duct.

### FIGURES—REFERENCE NUMERALS

10—Induction Heating and Melting Device

12—Crucible

14—Inner Layer

16—Outer Layer

18—Induction Coil

20—Insulation Layer

22—Fan

24—Air Duct

26—Air

28—Control Panel

30—Power Source

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

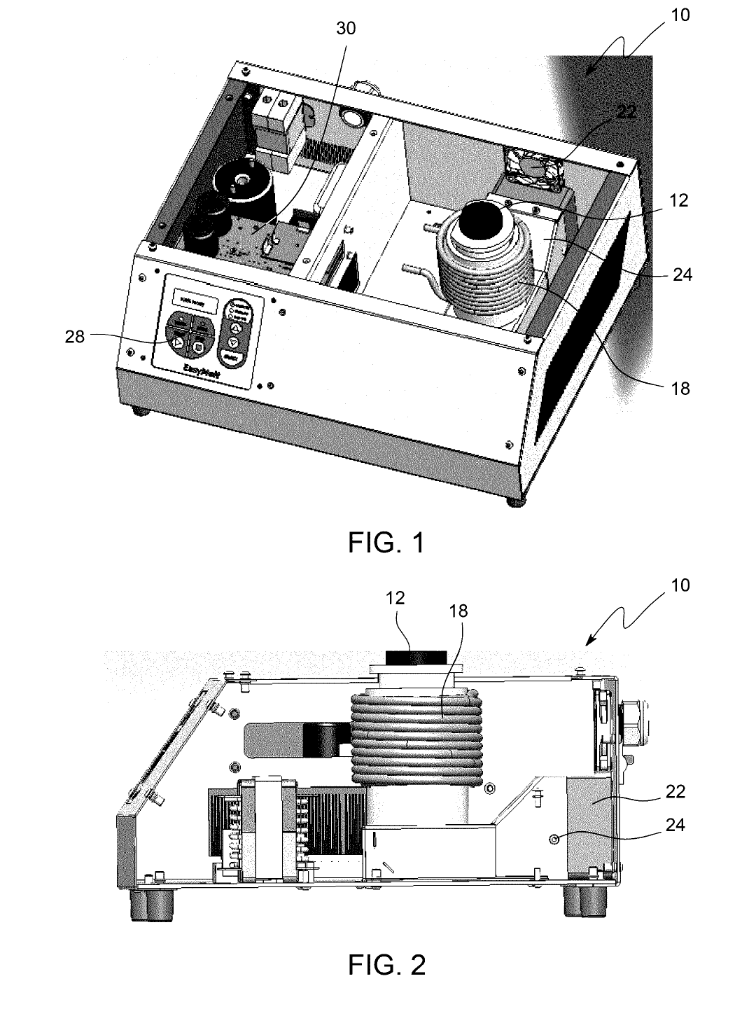

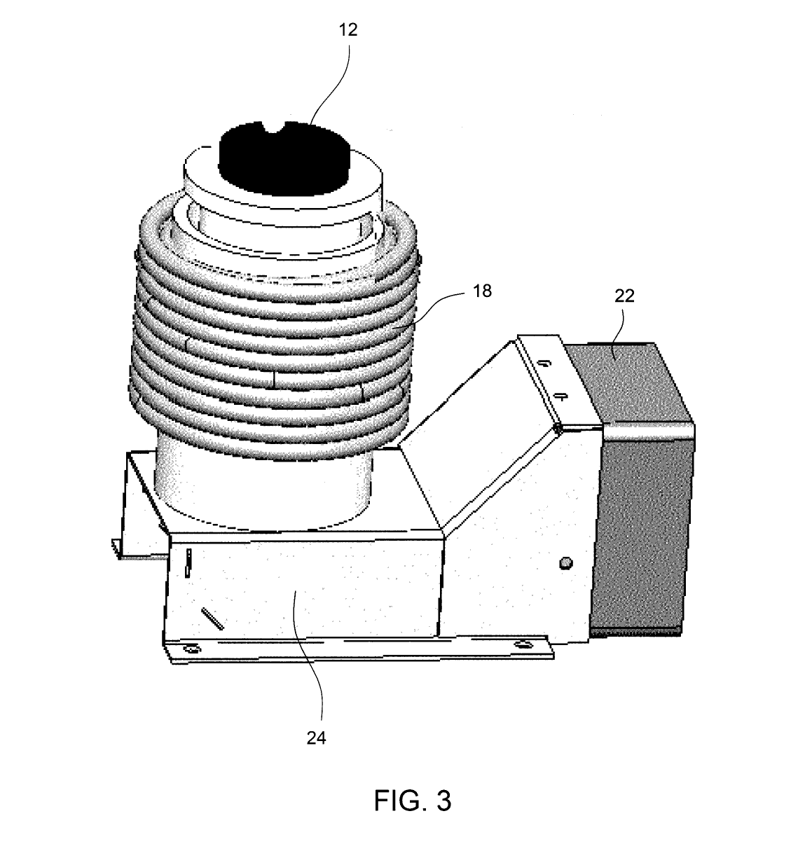

Referring to FIGS. 1 through 4, the present invention comprises a device 10 for inductively heating and subsequently melting a metal, which preferably comprises a metal of a relatively low melting point such as, gold, silver, brass, copper, etc. The device 10 comprises a crucible 12—a graphite susceptor, the inner and outer layers 14 and 16 of which are inlaid with a graphite layer and a thermal fiber layer respectively. Alternatively, the outer layer 16 may comprise ceramic. The bottom of the crucible 12 has a conical shape, the utility of which will become apparent from the following body of text.

Referring to FIGS. 1 through 4, the device 10 further comprises an induction coil 18 spirally wound around (not over) the crucible 12 such that, no contact is observed between the induction coil 18 and the crucible 12. The conical bottom of the crucible 12 helps in keeping the crucible 12 from getting into contact with the induction coil 18. Further, the induction coil 18 is disposed around the crucible 12 such that, the crucible 12 is centrally-disposed with respect to the induction coil 18. The coil 18 is made of high temperature litz or welding wire and lined with a thermal insulation layer 20, such as, of thermal epoxy, so as to provide sufficient thermal barrier between the induction coil 18 and the susceptor. In one embodiment, in order to provide additional thermal barrier between the susceptor and the induction coil 18, the induction coil 18 is further layered with additional layers, which may either be thermal insulating layers or layers of a refractory material.

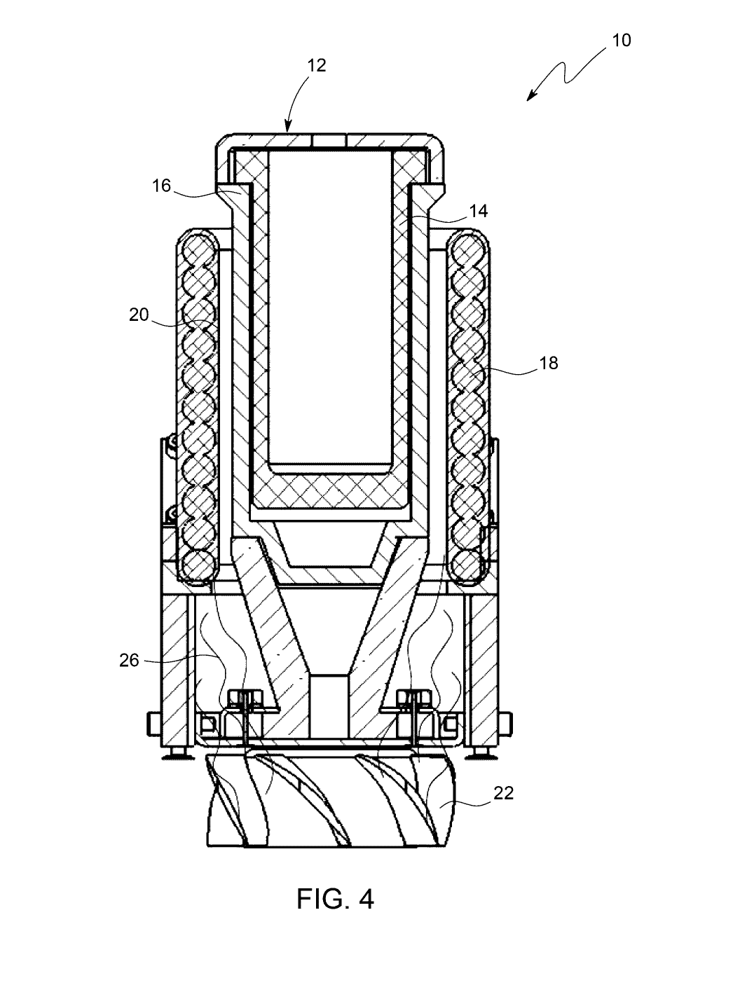

Referring to FIGS. 1 through 4, the device 10 further comprises a fan 22 secured at one end of an air duct 24 wherein, the air 26 from the fan 22, as directed by the air duct 24, is delivered to the annular gap disposed between the induction coil 18 and the outer surface of the crucible 12 so as to air-cool the induction coil 18. More particularly, as can be appreciated from FIG. 4, the air duct 24 is disposed below the crucible 12 such that, the axis of the crucible 12 is in line with that of the air duct 24. In one embodiment, as can be from FIGS. 1 through 3, the air duct 24 is disposed below the crucible 12 perpendicularly thereto. In one embodiment, the air 26 is pre-cooled before being delivered to the induction coil 18. In device 10 further comprises an additional fan 22 for directing the air therefrom to the outer surface of the induction coil 18.

Referring to FIGS. 1 through 4, the device 10 further comprises a power source 30 for powering up the induction coil 18 via a control panel 28. Powering the induction coil 18 results in the generation of an electromagnetic field (by the induction coil 18), which inductively heats up and subsequently melts the metal within the crucible 12.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. For example, the protective case assembly can be adapted to accommodate a tablet PC by simply altering the dimensions thereof. However, all such modifications are deemed to be within the scope of the claims.

What is claimed is:

1. An air-cooled induction heating device comprising:
(a) a crucible for receiving a metal therewithin;
(b) an induction coil spirally encircling the crucible such that, no contact is observed therebetween;
(c) a power supply source for powering the induction coil;
wherein, powering the induction coil results in the inductively heating up and subsequent melting of the metal.

2. The device of claim 1 wherein, the inner surface of the crucible comprises graphite layer.

3. The device of claim 1 wherein, the outer surface of the crucible comprises ceramic layer.

4. The device of claim 1 wherein, the outer surface of the crucible comprises thermal fiber layer.

5. The device of claim 1 wherein, the bottom of the crucible is conical in shape.

6. The device of claim 1 wherein, the crucible is concentric with respect to the coil.

7. The device of claim 1 further comprising:
(a) a fan; and
(b) an air duct for directing the air from the fan to the gap between the coil and the crucible.

8. The device of claim 7 wherein, the air is pre-cooled.

9. The device of claim 1 wherein, the induction coil is made of litz.

10. The device of claim 1 wherein, the induction coil is lined with a thermal epoxy.

11. The device of claim 10 wherein, the insulation coil is further layered with additional thermal insulation layers.

12. The device of claim 10 wherein, the insulation coil is further layered with a refractory material.

13. The device of claim 1 further comprising an additional fan for blowing air onto the outer surface of the induction coil.

14. An air-cooled induction heating device comprising:
(a) a crucible for receiving a metal therewithin, the inner and outer surfaces of the crucible comprising graphite and either ceramic or fiber respectively, the bottom of the crucible comprising a conical shape;
(b) an induction coil spirally encircling the crucible such that, no contact is observed therebetween, the induction coil made of litz, the crucible being concentric with respect thereto, the induction coil lined with a layer of thermal epoxy;
(c) a fan;
(d) an air duct for directing the air from the fan into the gap between the coil and the crucible; and
(e) a power supply source for powering the induction coil;
wherein, powering the induction coil results in the inductively heating up and subsequent melting of the metal.
